(19) United States
(12) Patent Application Publication
(10) Pub. No.: US 2017/0228328 A1
(43) Pub. Date: Aug. 10, 2017

(54) METHOD AND APPARATUS FOR PROVIDING SMALL FORM-FACTOR PLUGGABLE (“SFP”) NON-VOLATILE MEMORY (“NVM”) STORAGE DEVICES

(71) Applicants: Alan Armstrong, Los Altos, CA (US); Bernie Sardinha, Gilroy, CA (US)

(72) Inventors: Alan Armstrong, Los Altos, CA (US); Bernie Sardinha, Gilroy, CA (US)

(73) Assignee: CNEXLABS, Inc., San Jose, CA (US)

(21) Appl. No.: 15/424,343

(22) Filed: Feb. 3, 2017

Related U.S. Application Data
(60) Provisional application No. 62/291,398, filed on Feb. 4, 2016.

(51) Int. Cl. G06F 13/16; G06F 1/26; G06F 12/02; G06F 13/40; G06F 13/42

(52) U.S. Cl. CPC G06F 13/1673; G06F 13/4081; G06F 13/42; G06F 13/4022; G06F 12/0246; G06F 1/266; G06F 2212/7201

(57) ABSTRACT

A method and apparatus for configuring or fabricating a small form-factor (“SFP”) non-volatile memory (“NVM”) solid state drive (“SSD”) plug is disclosed. The SFP NVM SSD (“SNS”) plug capable of storing data persistently, in one embodiment, is configured to couple to an SFP socket of a digital processing system capable of accessing external storage. The SFP socket is capable of providing memory access and optical communication. The SNS plug includes a connector, interface module, memory controller, buffer, and NVM chip wherein the digital processing system host performs storage access to the NVM chip via the memory controller.

### PRIORITY

This application claims the benefit of priority based upon U.S. Provisional patent application having an application Ser. No. 62/291,398, filed on Feb. 4, 2016, and having a title of “Method and Apparatus for Logically Removing Defective Pages in Non-Volatile Memory Storage Device,” which is hereby incorporated by reference in its entirety.

### FIELD

The exemplary embodiment(s) of the present invention relates to the field of semiconductor and integrated circuits. More specifically, the exemplary embodiment(s) of the present invention relates to non-volatile memory (“NVM”) storage devices pluggable to small form-factor pluggable (“SFP”) sockets.

### BACKGROUND

With increasing popularity of electronic devices, such as computers, smart phones, mobile devices, server farms, mainframe computers, and the like, the demand for more and faster data is constantly growing. To handle and facilitate voluminous data between such electronic devices, NVM devices are typically required. A conventional type of NVM device, for example, is a flash memory based storage device such as solid-state drive (“SSD”).

The flash memory based SSD, for example, is an electronic NVM storage device capable of maintaining, erasing, and/or reprogramming data. The flash memory can be fabricated with several different types of integrated circuit (“IC”) technologies such as NOR or NAND logic gates with, for example, floating-gate transistors. Depending on the applications, the access to data stored in flash memory can be configured to be units of blocks, pages, words, and/or bytes.

A drawback associated with a typical flash based SSD is that conventional SSD has structural limitations, limited port configuration, as well as interface limitations.

### SUMMARY

One embodiment of the present invention discloses an SFP NVM SSD (“SNS”) plug or quad small form-factor (“QSFP”) NVM SSD (“QNS”) plug capable of facilitating high-speed external memory access via SFP or QSFP sockets or ports. The SFP or QSFP sockets or ports at a host, in one example, are capable of accessing storage memory as well as handling optical data. The SNS plug, in one embodiment, is configured to be pluggable to an SFP socket of a digital processing system such as a router or server. The SNS plug includes a connector, interface modules, memory controller, buffer, and NVM chip(s). The digital processing system such as a computer system is able to perform storage access to the NVM chip via the memory controller.

In operation, upon inserting a SNS plug into a SFP socket which is capable of facilitating optical communication at a host system, a handshaking process between the host system and the SNS plug, for example, is initiated using an Ethernet based protocol. After activating an NVM internal bus connecting to NVM array to reboot NVM storage blocks, the host system is allowed to see external memory space at the SNS plug.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating an SFP NVM SSD (“SNS”) plug configured to provide external storage space to a digital processing system via a standard coupling connector in accordance with one embodiment of the present invention;

FIG. 2 is a block diagram illustrating an SNS plug containing various modules in accordance with one embodiment of the present invention;

FIG. 3 is a diagram illustrating a physical layout of printed circuit board (“PCB”) 208 for an SNS plug in accordance with one embodiment of the present invention;

FIG. 4 is a block diagram illustrating a memory configuration for NVM within the SNS plug in accordance with one embodiment of the present invention;

FIG. 5 is a logic block diagram illustrating an access to NVM storage space in an SNS plug using flash translation layer (“FTL”) in accordance with one embodiment of the present invention;

FIG. 6 illustrates an SNS plug showing several structural diagrams with an SFP and/or QSFP physical configuration in accordance with one embodiment of the present invention;

FIG. 7 illustrates a physical layout associated with an SFP based SNS plug or QSFP based SNS plug in accordance with one embodiment of the present invention;

FIG. 8 is a diagram illustrating an exemplary module card with edge pins used in an SNS plug for coupling to a host system in accordance with one embodiment of the present invention;

FIG. 9 is a diagram illustrating an exemplary power supply for QSFP based SNS plug drawing power from a host in accordance with one embodiment of the present invention;

FIG. 10 illustrates physical diagrams showing an exemplary QSFP based SNS plug with packaged dies in accordance with one embodiment of the present invention;

FIG. 11 is a structural diagram illustrates an alternative configuration of SNS plug using NVM packaged in Fine Pitch Ball Grid Array (“FPBA”) in accordance with one embodiment of the present invention;

FIG. 12 is a block diagram illustrating an integrated circuit (“IC”) organized in 3D stacking configuration used in SNS plug in accordance with one embodiment of the present invention;

FIG. 13 illustrates exemplary QSFP and SFP MSA components including cable(s) that can be used for SNS plug or network communication in accordance with one embodiment of the present invention;

FIG. 14 is a block diagram illustrating a processing device or computer system 1400 which can be used as controller in accordance with one embodiment of the present invention; and

FIG. 15 is a flowchart illustrating a process of memory access to an SNS plug in accordance with one embodiment of the present invention.

### DETAILED DESCRIPTION

Embodiments of the present invention are described herein with context of a method and/or apparatus for providing small form-factor pluggable (“SFP”) non-volatile memory (“NVM”) SSD device(s).

The purpose of the following detailed description is to provide an understanding of one or more embodiments of the present invention. Those of ordinary skills in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

In accordance with the embodiment(s) of present invention, the components, process steps, and/or data structures described herein may be implemented using various types of operating systems, computing platforms, computer programs, and/or general purpose machines. In addition, those of ordinary skills in the art will recognize that devices of a less general purpose nature, such as hardware devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

One embodiment of the present invention discloses a device and/or method of configuring or fabricating non-volatile memory (“NVM”) solid state drive (“SSD”) into a small form-factor pluggable (“SFP”) or quad small form-factor pluggable (“QSFP”) memory device. With various existing SFPs and/or QSFP ports used by switches/routers for network communication, SSD type of storage device capable of being directly plugged into such SFP or QSFP ports can be useful and effective because such configuration can save space, power consumption, and complexity.

One embodiment of the present invention discloses an SFP NVM SSD (“SNS”) plug or quad small form-factor (“QSFP”) NVM SSD (“QNS”) plug capable of facilitating high-speed external memory access via SFP or QSFP sockets or ports. The SFP or QSFP sockets or ports at a host, in one example, are capable of accessing storage memory as well as handling optical data. The SNS plug, in one embodiment, is configured to be pluggable to an SFP socket of a digital processing system such as a router or server. The SNS plug includes a connector, interface modules, memory controller, buffer, and NVM chip(s). The digital processing system such as a computer system is able to perform storage access to the NVM chip via the memory controller.

In operation, upon inserting a SNS plug into a SFP socket which is capable of facilitating optical communication at a host system, a handshaking process between the host system and the SNS plug, for example, is initiated using an Ethernet based protocol. After activating an NVM internal bus connecting to NVM array to reboot NVM storage blocks, the host system is allowed to see external memory space at the SNS plug.

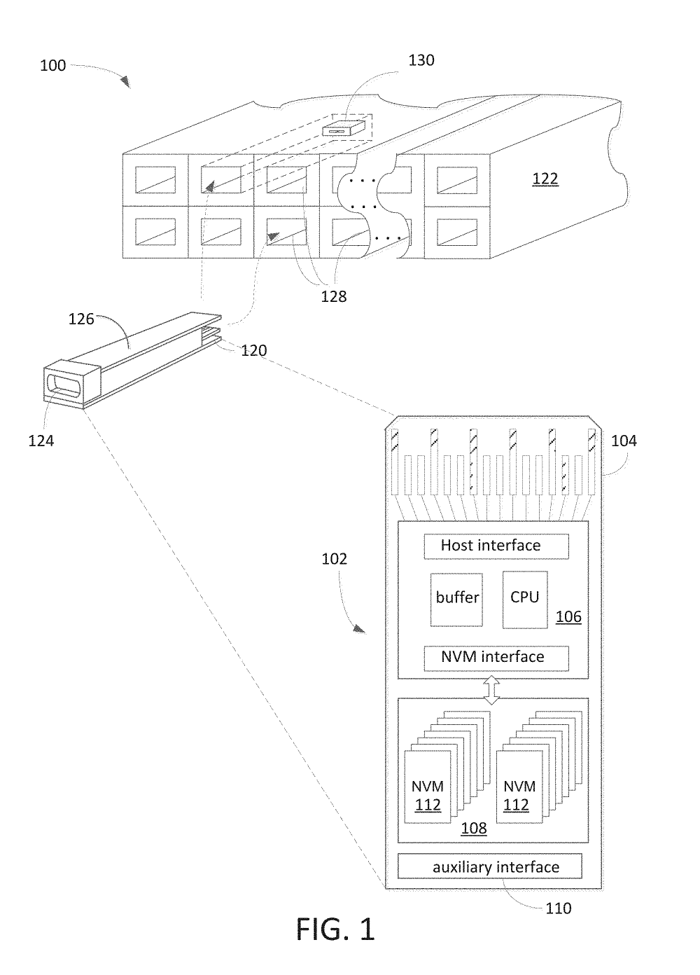

FIG. 1 is a block diagram 100 illustrating an SNS plug capable of providing external storage space to a digital processing system via a standard coupling connector in accordance with one embodiment of the present invention. Diagram 100 includes a digital processing system 122 and SNS plug 126 wherein digital processing system 122, in one example, can be a server, host, network router, network switch, base station, computer, mainframe computer, and the like. A function of digital processing system 122 is capable of executing instructions, storing data, and transmitting information via a network. It should be noted that the underlying concept of the exemplary embodiment(s) of the present invention would not change if one or more blocks (or devices) were added to or removed from diagram 100.

Digital processing system 122, in one example, is a network router which includes multiple ports 128 used for network communications. The network router, for example, includes a group of ports physically configured in small form factor sockets such as SFP or QSFP sockets. Each SFP socket, for instance, includes a connector 130 which is used to electrically couple to connector of a plug. A function of SFP socket, in one example, is to facilitate electrical data storage as well as optical data communication with optical transceiver.

The SFP format is generally relating to small size pluggable transceiver used for data communications. It should be noted that the form factor and electrical interface are standard defined by a multi-source agreement (“MSA”) under the SFF (small form factor) committee. An application of such SFP is to facilitate network communication between optical data and electrical data. For instance, SFP transceivers support various communication methods, such as, but not limited to, SONET, gigabit Ethernet, Fibre Channel, and other communications standards.

SNS plug 126, in one embodiment, has a front side 120 and back side 124 wherein front side 120 and back side 124 are connected by a printed circuit board (“PCB”) 102. PCB 102, in one aspect, includes a connector 104, memory controller 106, NVM 108, and auxiliary interface 110. While connector 104 is used to couple to socket connector 130, memory controller 106, also known as controller, includes a host interface module, CPU, buffer, and NVM interface. NVM 108, in one example, includes one or more NVM dies having a storage range from 64 GB to 128 TB. Auxiliary interface 110, in one aspect, is used to provide extended storage capacity. Alternatively, auxiliary interface 110 can also be used to couple to a second SFP plug or optical SFP transceiver.

In operation, SNS plug 126 can be inserted into any one of SFP sockets 128 at digital processing system 122 wherein front side 120 of SFP plug 126 enters an SFP socket 128 to reach connector 130. After handshaking initialization between SNS plug 126 and digital processing system 122, digital processing system 122 can access NVM 108 via SNS plug 126. In one example, digital processing system 122 views SNS plug 126 as a high-speed external storage memory for data storage.

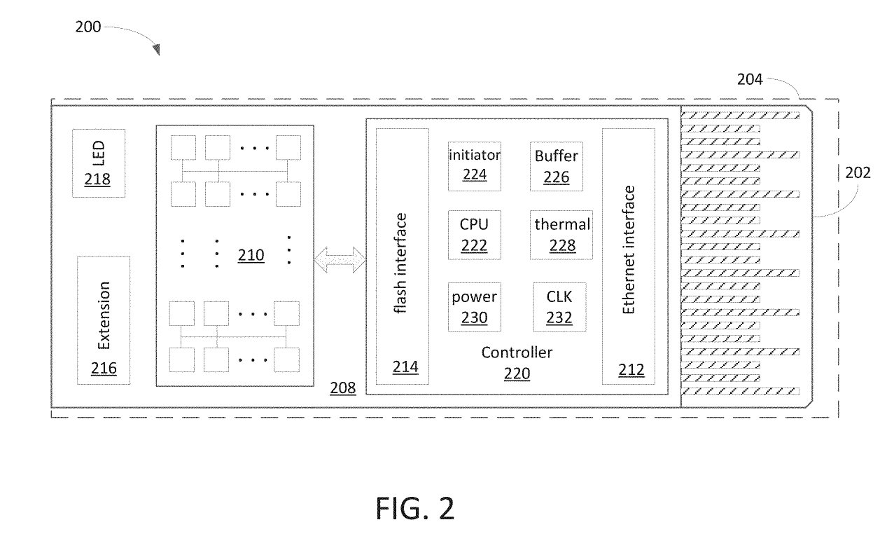

FIG. 2 is a block diagram 200 illustrating an SNS plug containing various modules in accordance with one embodiment of the present invention. Diagram 200 includes a housing 204 and PCB 208 wherein PCB 208 further includes an SFP connector 202, memory controller 220, and NVM or NVM array 210. A function of housing 204 is to house SNS plug while dissipating heat generated by the SNS plug. It should be noted that the underlying concept of the exemplary embodiment(s) of the present invention would not change if one or more blocks (or modules) were added to or removed from diagram 200.

SFP connector 202, in one embodiment, is physically configured so that it can be inserted or plugged into an SFP socket of a digital processing system such as a network router. SFP connector 202, for example, includes multiple pins configured to provide electrical connection to a host computer when the SNS plug is inserted into the SFP socket of host computer. A host computer, for example, can be a switching router containing multiple ports wherein some of these ports are configured to SFP configurations. It should be noted that a network system such as router may contain multiple SFP ports used for optical communication.

SFP connector 202 includes one or more power pins that are used to draw power from the SFP socket of a host for power supply. In one example, the host or digital processing system, which can be a network router, network switch, networking hub, computer, server, or a cluster of routers, switches, hubs, and servers, provides power to its SFP ports. It should be noted that SFP connector 202 can also be configured to comply with QSFP or XSFP (10 Gigabit SFP) configurations or specifications. A benefit of using an SNS plug is that it can be directly plugged into an existing SFP or QSFP sockets at a switch or router whereby it takes up minimum space while provides substantial amount of storage capacity.

Controller or memory controller 220, in one aspect, includes multiple modules, such as, but not limited, Ethernet interface 212, flash interface 214, CPU (central processing unit) 222, initiator 224, buffer 226, thermal module 228, power module 230, and clock module 232. A function of memory controller 220 is to manage and facilitate data transmission between NVM 210 and a connected host via connector 202. To facilitate memory management, controller 220, in one embodiment, uses a translation layer such as flash translation layer (“FTL”) to manage and control data access to and from NVM 210.

Ethernet interface 212, also known as host interface or interface module, includes one or more input output (“IO”) modules used for facilitating data transmission between a host and NVM chip(s). For instance, Ethernet interface 212 is able to facilitate high-speed data transfer between a host and NVM dies using Ethernet based protocol such as NVMoE™ (NVM over Ethernet) protocol. Flash interface 214, also known as NVM interface, is an NVM interface module configured to communicate or interface with NVM 210. In one aspect, flash interface 214 and Ethernet interface 212 are coupled in such a way that data can be efficiently transmitted between NVM 210 and a host system via connector 202.

CPU 222 is a digital processor capable of control various operations and functions provided by the SNS plug via execution of instruction. For example, CPU 222 assists controller 220 to perform various SSD operations, such as, but not limited to, storing data persistently, reading data, transmitting data, recycling storage space, and/or organizing storage space using FTL.

Initiator 224, also known as plug initiator, is coupled to CPU 222 and facilitates system reboot function via boot bios. Initiator 224, in one aspect, is responsible for monitoring handshaking process between the SNS plug and the host when the SNS plug is initially plugged into a port of host. The functions of hot plugging and hot unplugging are managed and/or assisted by initiator 224. The handshaking process is a process of negotiating and establishing various communication parameters and channel(s) between two devices such as a router and SNS plug when the two devices are initially connected. Hot plugging or hot unplugging which is also known as hot swapping is a process of replacing or adding components without stopping or shutting down the system with minimum interruption to the normal operation of the system.

Buffer 226, in one aspect, is volatile memory such as DRAM (dynamic random access memory) configured to buffer data during NVM memory access operation. A function of buffer is to enhance NVM efficiency by temporarily storing data before it is being written to NVM permanently.

Thermal module 228 is used to regulate thermal temperature or condition within the SNS plug. For example, thermal module 228 is able to dissipate heat through housing 204 of the SNS plug. The housing 204 can be fabricated with thermal conductive material such as aluminum. Note that the SNS plug can produce a large amount of heat depending on the type of NVM used. Alternatively, thermal module 228 can also shut down certain functions and/or modules in the SNS plug if thermal module 228 detects that the temperature in the SNS plug exceeds a predefined thermal limit. Also, thermal module 228 is configured to communicate with clock module 232 to adjust clock speed based on the thermal conditions. Clock module 232 generates cycles which are fed to other modules such as CPU 222.

Power module 230, in one embodiment, is able to provide power supply to various modules and NVM 210 using power supplied by the host via connector 202. For example, power module 230 is able to draw power from an SFP socket of host and redistributes the power to fulfill power requirements for the SNS plug. Depending on the type of NVM, different power consumption level may be required. It should be noted that several different types of NVM may be used in the SNS plug.

NVM, NVM chip, or NVM die 210, in one example, includes multiple flash based IC dies having a storage capacity between one (1) gigabytes (“GB”) and 64 terabytes (“TB”). NVM 210, in one aspect, is organized in planes, blocks, and pages based on SSD configuration. PCB 208 also includes extension 216 and LED (light emitting diode) module 218. LED module 218 is used to indicate the status of the plug while extension 216 is used to provide additional connections.

The SNS plug, in one aspect, is an NVM SSD using Ethernet based protocol, such as NVMoE for providing additional data storage to existing apparatus via connectors such SFP and/or QSFP. For example, the SNS plug is configured and/or integrated into an SFP/QSFP form-factor whereby it can be directly plugged into a network switch fabric for providing multi-terabytes storage space. Depending on the applications, any types of volatile or nonvolatile media such as NAND Flash, DRAM, RRAM, MRAM, and the like can be used. For example, a 10-to-40 gigabits per second (“Gb/s”) Ethernet port in a switch may be occupied by an SNS plug configured in small form-factor to provide a terabyte storage space using Ethernet based protocol.

An advantage of using an SNS plug is that it provides additional storage space to an existing port at the host with minimum space requirement.

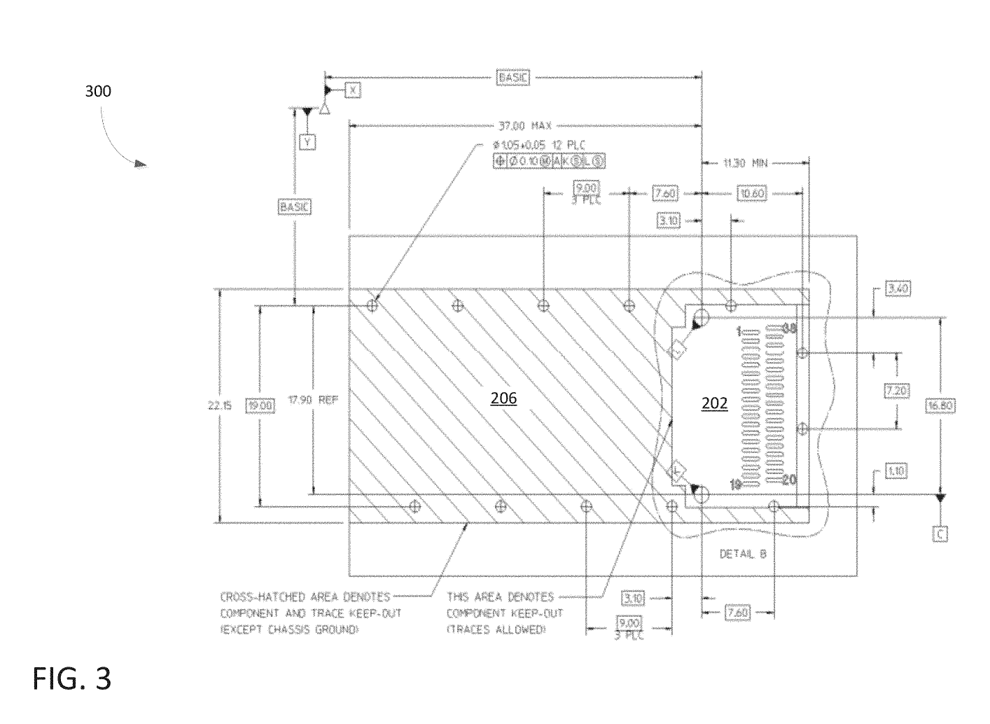

FIG. 3 is a diagram 300 illustrating a physical layout of PCB 208 for an SNS plug in accordance with one embodiment of the present invention. PCB 208 includes connector 202 and multiple anchoring holes 308. Diagram 300 illustrates an exemplary dimension for the PCB 208. For example, the width of PCB 208 is 22.15 mm (millimeter) and the length of PCB 208 is 48.30 mm as indicated by numerals 304-306. It should be noted that the dimension for SFP is approximately 8.5 mm in height (“H”), 13.4 mm in width (“W”), and 56.5 mm in depth (“D”). While the approximate dimension for XSFP is 8.5 mm in H, 18.4 mm in W, and 78.0 mm in D, the approximate dimension for QSFP can be 13.5 mm in H, 18.4 mm in W, and 72.4 mm in D. It should be noted that the underlying concept of the exemplary embodiment(s) of the present invention would not change if one or more blocks (or measurements) were added to or removed from diagram 300.

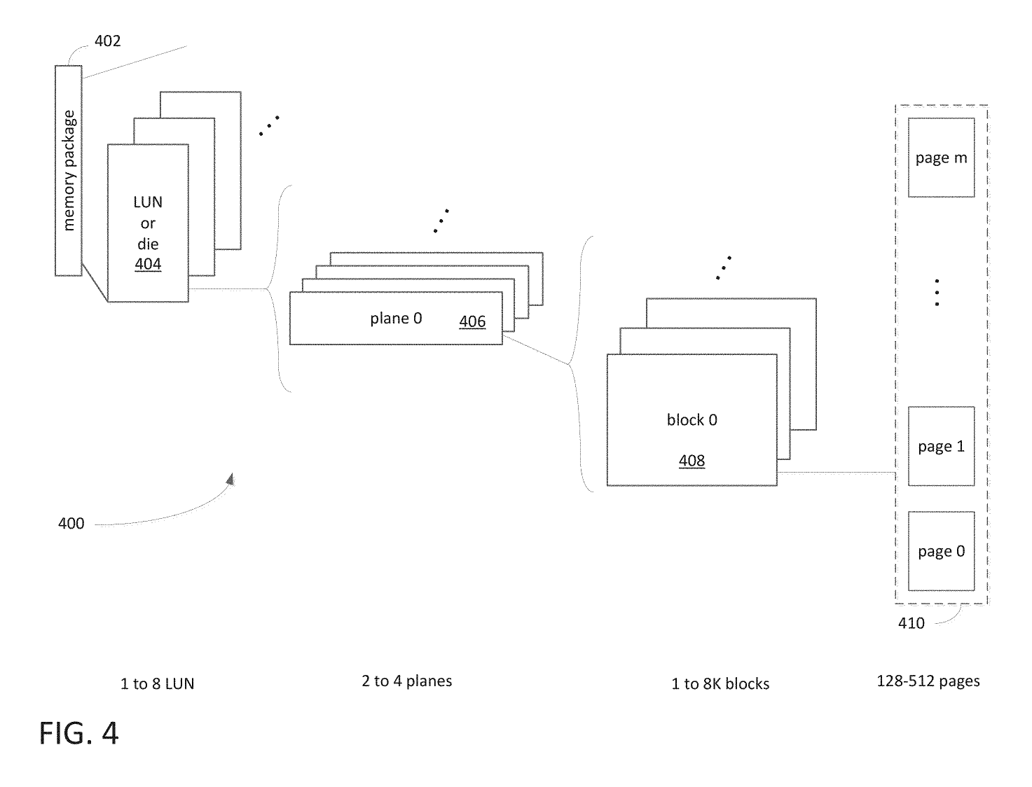

FIG. 4 is a block diagram illustrating a memory configuration for NVM within the SNS plug in accordance with one embodiment of the present invention. Diagram 400 includes a memory package 402 which can be a memory chip containing one or more NVM dies or logic units (“LUNs”) 404. A flash memory, for example, has a hierarchy of Package-Silicon Die/LUN-Plane-Block-Flash Memory Page-Word line configuration(s). It should be noted that the underlying concept of the exemplary embodiment(s) of the present invention would not change if one or more blocks (or devices) were added to or removed from diagram 400.

NVM memory device such as a flash memory package 402 contains one or more flash memory dies or LUNs wherein each LUN or die 404 is further organized into more NVM or flash memory planes 406. For example, die 404 may have a dual planes or quad planes. Each NVM or flash memory plane 406 can include multiple memory blocks or blocks. In one example, plane 406 can have a range of 1000 to 8000 blocks 408. Each block such as block 408 can have a range of 64 to 512 pages. For instance, a flash memory block can have 256 or 512 pages 410.

A flash memory page, for example, can have 8 KBytes or 16 KBytes of data plus extra redundant area for ECC parity data to be stored. One flash memory block is the minimum unit of erase. One flash memory page is the minimum unit of program. To avoid marking an entire flash memory block bad or defective which will lose anywhere from 256 to 512 flash memory pages, a page removal or decommission can be advantageous. It should be noted that 4 Megabytes (“MB”) to 16 MB of storage space can be saved to move from block decommissioning to page decommissioning.

Note that based on flash memory characteristics, a relatively small number of flash memory pages can usually be defective or become bad or unusable when the flash memory page PE (program erase) cycles, for example, are getting higher. For example, the bad page during program or read operation of that flash memory page can be discovered. A bad page can also be discovered if that page has much higher read errors during the normal read work load. A bad page can be further discovered when that page is bad and other pages in the same block are good.

SFP NVM storage device is a pluggable device designed for use with small form factor (“SFF”) connectors which offer high-speed, physical compactness, and the versatility of utilizing existing networking sockets for storage. For example, such SFF connectors are used by switches and routers for transmitting electrical as well as optical information. An advantage of using SFP NVM storage device is hot-swappable.

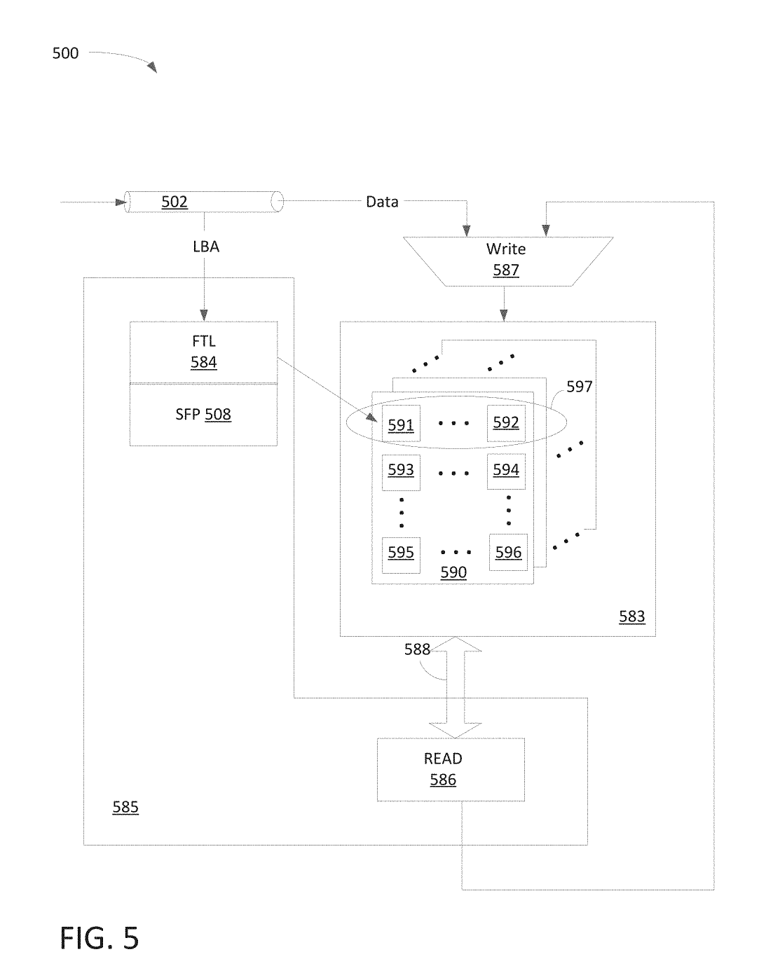

FIG. 5 is a logic block diagram illustrating an access to NVM storage space in an SNS plug via flash translation layer (“FTL”) in accordance with one embodiment of the present invention. Diagram 500 includes input data 502, storage device 583, output port 588, and storage controller 585. Storage controller 585 further includes read module 586, FTL 584, SFP module 508, and/or write module 587. A function of FTL 584 is, for example, to map LBA to physical address(s). It should be noted that the underlying concept of the exemplary embodiment(s) of the present invention would not change if one or more blocks (or devices) were added to or removed from diagram 500.

SFP module 508, which could be part of FTL 584, is configured to implement and/or facilitate SSD functions in the SNS plug. For example, SFP module 508 is responsible to communicate with host(s) using small form factor connection. Also, SFP module 508 facilitates the handshaking process between SNS plug and host upon initial connection.

Storage device 583, in one example, is flash based NVM containing multiple arrays of flash memory cells for storing data persistently. The flash memory, which generally has a read latency less than 200 microseconds (“μs”), is organized in blocks and pages wherein a minimum access unit, for example, can be set to four (4) kilobyte (“Kbyte”), eight (8) Kbyte, or sixteen (16) Kbyte memory capacity depending on the flash technologies. To simplify forgoing discussion, a four (4) Kbyte page or flash memory page (“FMP”) is used.

Referring back to FIG. 5, storage device 583 is organized into multiple NVM blocks 590 wherein each block such as block 590 further includes a set of pages or FMPs 591-596. Each page such as page 591 has a capacity or size capable of storing 4096 bytes or 4 Kbyte of information. Each block such as block 590, in one example, may contain a range of pages from 128 to 512 pages (or sectors) 591-596. A page, in one example, is generally a minimal writable or readable unit while a block is a minimal number to perform an erase function. Flash memory 583 can persistently retain information or data for a long period of time without power supply.

FTL 584, which may be implemented in DRAM, includes a FTL database or table that stores mapping information. For example, the size of FTL database is generally a positive proportion to the total storage capacity. For instance, one way to implement the FTL in SSD is that it uses a DRAM size that approximately equals to 1/1000 of SSD capacity. Since each page has a 4-Kbyte capacity and each entry of FTL database has a 4-byte capacity of entry, the size of FTL database can be calculated as SSD capacity/4 KByte*4 KByte (SSD capacity/1000) which is approximately 1 over 1000 (or 1/1000).

In operation, upon receipt of data input or data packets 502, FTL 584 maps LBA to physical page address (“PPA”) in storage device 583. After identifying PPA, write circuit 587 writes the data from data packets 582 to a page or pages within a block pointed by PPA. In one aspect, MNS 508 allocates or divides storage space into basic storage units wherein the storage capacities for the basic storage units are essentially the same or similar. Based on the incoming command, one or more basic storage units can be assigned or allocated to one NSID.

It should be noted that storage device 583 can also include NAND flash memory, NOR flash memory, phase change memory (“PCM”), nano random access memory (“NRAM”), magneto-resistive RAM (“MRAM”), resistive random-access memory (“RRAM”), programmable metallization cell (“PMC”), magnetic storage media (e.g., hard disk, tape), optical storage media, or the like. To simplify the forgoing discussion, the flash memory or flash memory based SSD is herein used as an exemplary NVM or NV storage device.

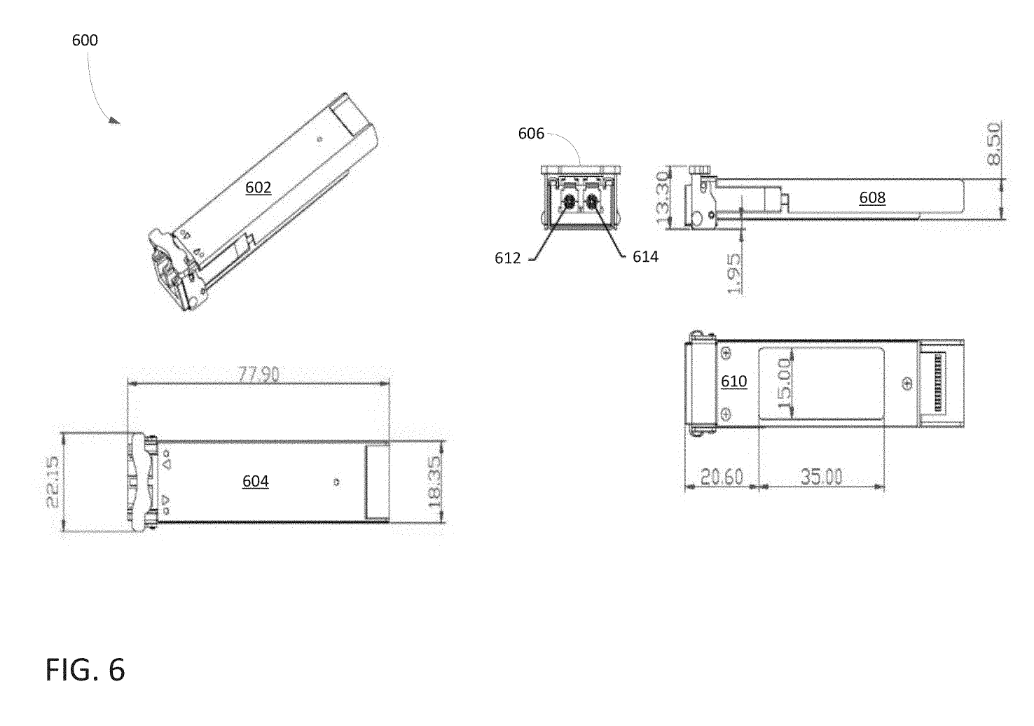

FIG. 6 illustrates an SNS plug 600 showing several structural diagrams 602-610 with an SFP and/or QSFP physical dimensions in accordance with one embodiment of the present invention. Diagram 602 illustrates a three dimensional (“3D”) structural diagram showing an SNS plug. Diagram 604 illustrates a top view of SNS plug with dimensions. Diagram 606 illustrates a back view of SNS plug containing two connectors 612-614 which can be used for extension of additional connections. Diagram 608 is a side view of SNS plug with dimensions. Diagram 610 is a top view of SNS plug with connector 202. FIG. 6 shows different views of SFP or QSFP housings, cages, and/or sockets. It should be noted that the dimensions shown in FIG. 6 are for illustrative purposes. Any other dimensions with different configuration can be used to house SNS plug or SFP NVM storage device.

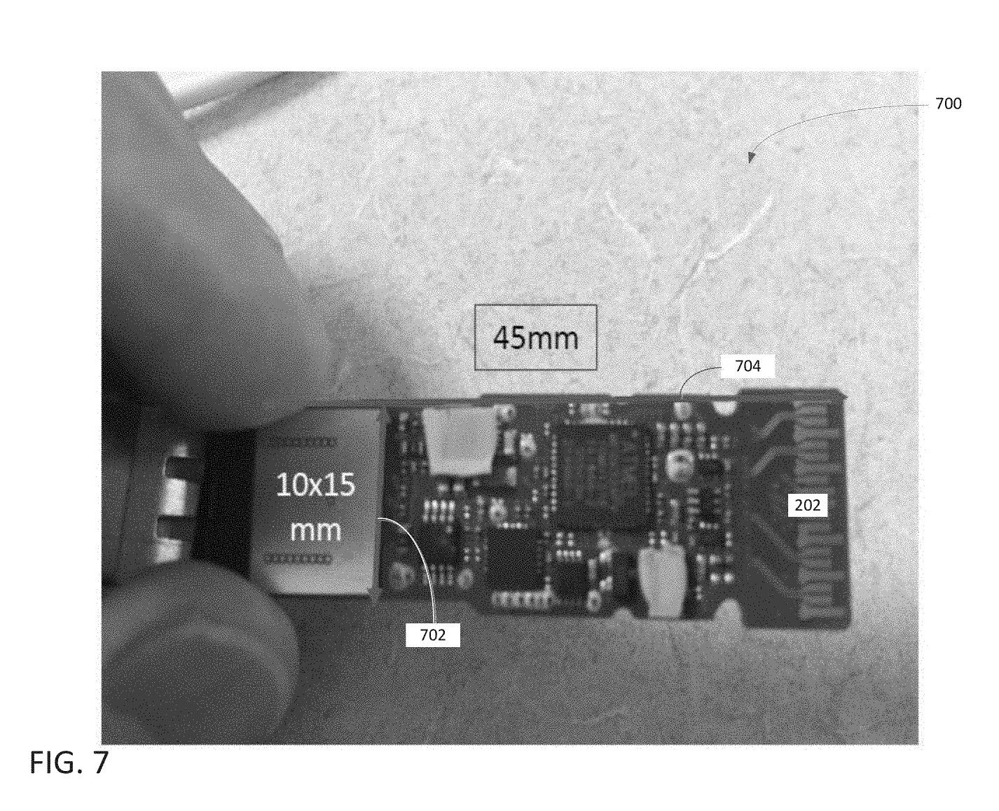

FIG. 7 is a physical layout 700 associated with an SFP based SNS plug or QSFP based SNS plug in accordance with one embodiment of the present invention. Layout 700 illustrates a PCB having a connector 202 and multiple chips. The PCB, which is separated from it casing, contains storage components. Layout 700 is a pictorial view of the PCB containing an SFP or QSFP storage components for an SNS plug which is pluggable to an existing Ethernet switch port. It should be noted that PCB has a dimension of 45 mm in length and 10 mm in width capable of storing several terabyte data.

In one embodiment, the SNS plug is able to use existing SFP/QSFP MSA form-factor to deliver a fully functional SSD device. The advantage of using an SNS plug is that it allows plugging the SNS plug directly into a switched fabric or similar computer type appliance using existing power supply at the connector. It should be noted that switched fabric or switching fabric is directed to a network containing interconnected nodes via one or more network switches.

An advantage of using SNS plug is that the plug follows MSA mechanical form-factor, thermal and electrical specifications. Another advantage of employing SNS plug is that it uses non-volatile and/or volatile storage media devices with no limitations on media or storage size. The SNS plug, in one example, can use hot plugging/unplugging and on-board serial flash for boot bios. The SNS plug, in one embodiment, includes LEDs on the back side of SNS plug as the SNS plug inserted into a switch media port for indicating plug status. For example, when LED emits green light, it means that the operation in SNS plug is normal. If the LED emits yellow light, it means that the plug needs attention. If the LED emits red light, it means the plug has been failed or in failure mode.

It should be noted that with limited PCB area, the availability of power is likely to be limited. For example, while voltage regulator needs to be at least 90% efficient, the maximum power should be between 1.5 and 3.5 W (watt). Also, the TIM (thermal interface material) is used for both controller and NAND devices. ESD, in one example, should be around 8 KV external, 2K at the connector.

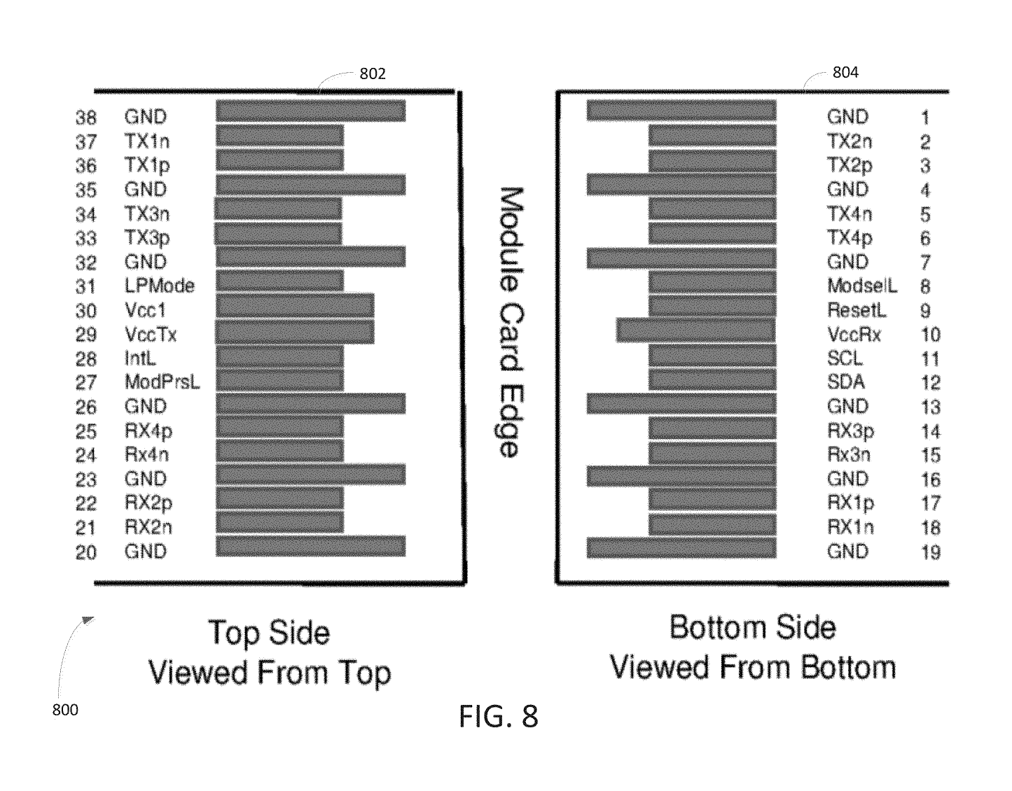

FIG. 8 is a diagram 800 illustrating an exemplary module card with edge pins used in an SNS plug for coupling to a host port in accordance with one embodiment of the present invention. Edge pins 802-804 includes approximately 40 pins wherein edge pins 802 illustrates a top view of the connector with top pins and edge pins 804 illustrates a bottom view of connector with bottom pins. It should be noted that some pins are power pins such as pin numbers 10, 29, and 30.

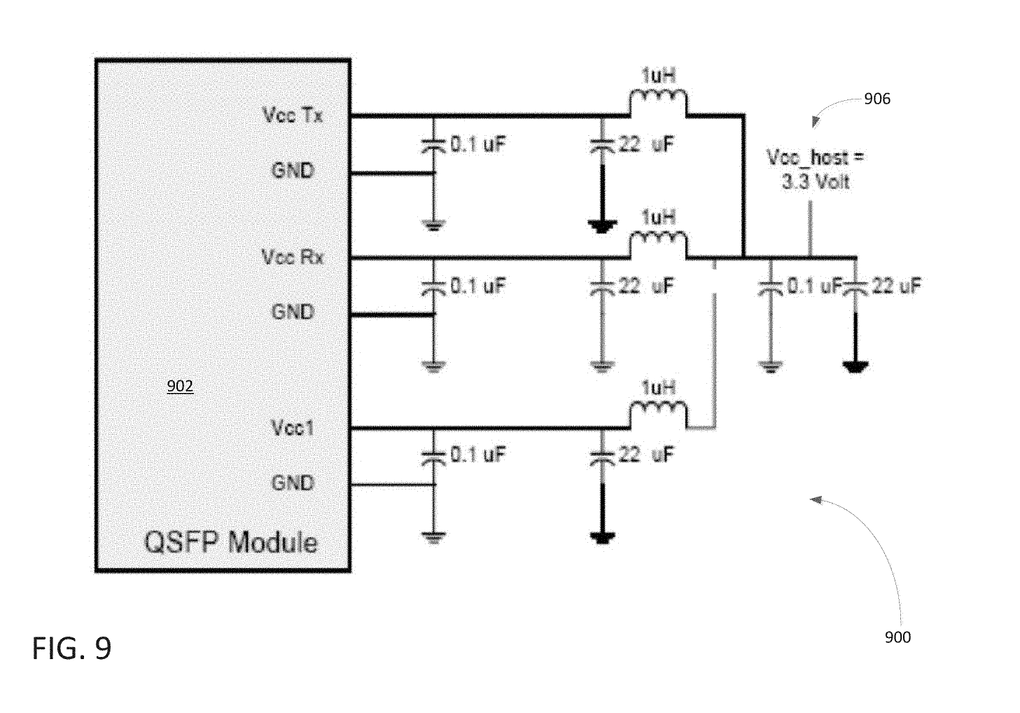

FIG. 9 is a diagram 900 illustrating an exemplary power supply for QSFP based SNS plug obtaining power from a host in accordance with one embodiment of the present invention. Diagram 900 includes a QSFP module containing Vcc and GND (ground) terminal pins capable of obtaining power from host as indicated by numeral 906. Table 1, shown below, illustrates an exemplary QSFP power requirements relating to instantaneous and sustainable peak currents for Vcc1 Vcc Tx, and/or Vcc Rx used by the SNS plug.

TABLE 1
power supply specification

| Parameter | Min | Nominal | Max | Unit | Condition |
|---|---|---|---|---|---|
| Vcc | | 3.3 | | V | Measure at Vcc Tx, |
| | | | | | Vcc Rx and Vcc1 |
| Vcc set point | −5 | | 5 | | Measure at Vcc Tx, |
| accuracy | | | | | Vcc Rx and Vcc1 |
| Power supply | | | 50 | Mv | 1 kHz to frequency |
| Noise including | | | | | of operation measured |
| ripple | | | | | at Vcc host |
| Sustained peak | | | 495 | mA | |
| current at hot | | | | | |
| plug with | | | | | |
| LPMode pin | | | | | |
| asserted | | | | | |
| Maximum | | | 600 | mA | |
| instantaneous | | | | | |
| current with | | | | | |
| LPMode | | | | | |
| asserted | | | | | |
| Module | | | 750 | mA | |
| sustained peak | | | | | |
| current with | | | | | |
| LPMode pin | | | | | |
| deasserted | | | | | |
| Maximum | | | 900 | mA | |
| instantaneous | | | | | |
| current with | | | | | |
| LPMode | | | | | |
| deasserted | | | | | |

Table 2, shown below, illustrates exemplary power levels associated with classifications of modules.

TABLE 2

| Power level | Max Power (W) |
|---|---|
| 1 | 1.5 |
| 2 | 2 |
| 3 | 2.5 |
| 4 | 3.5 |

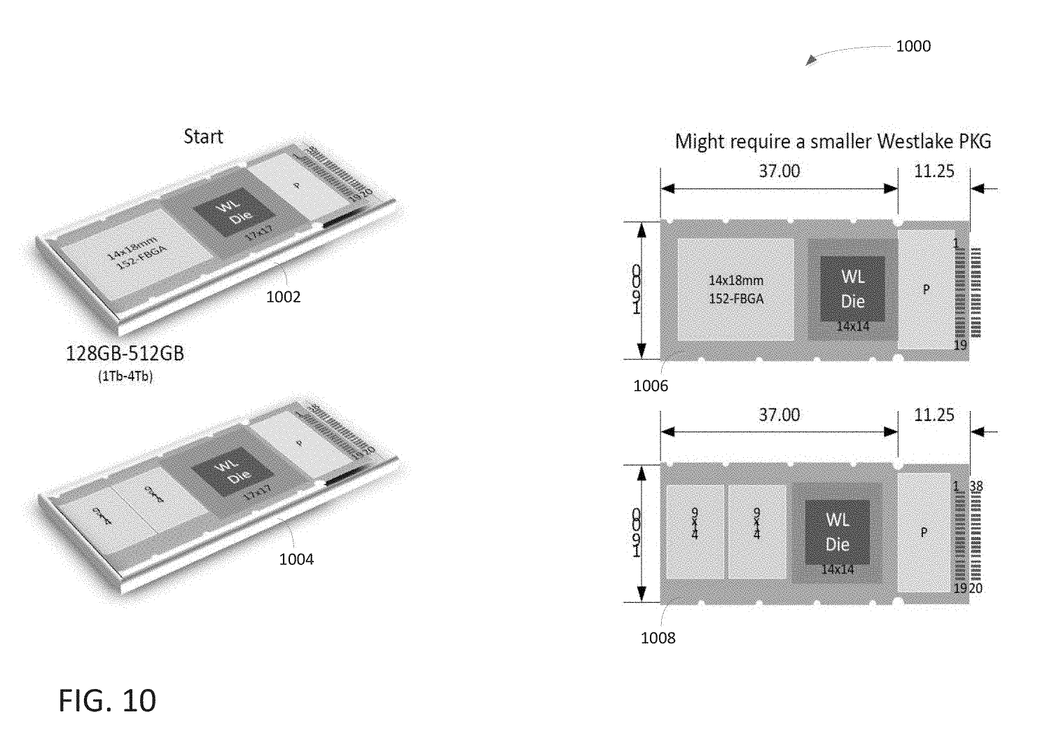

FIG. 10 illustrates physical diagrams 1002-1008 showing an exemplary QSFP based SNS plug with packaged dies in accordance with one embodiment of the present invention. Diagram 1002 illustrates a cutaway view of PCB 1010 mounted to a housing 1012 wherein PCB 1010 includes connector 202 with various pins, controller 1016, and NVM chip 1018. NVM chip 1018, in one aspect, is a 14×18 mm memory die capable of storing voluminous data having a range from 128 GB to 4 TB. Diagram 1004, which is similar to diagram 1002 except that housing 1012 has been removed, illustrates PCB 1010 with dimensions. Diagram 1006, which is similar to diagram 1002 except that different NVM chip is used, illustrates a cutaway view of PCB 1011 mounted to a housing 1013 wherein PCB 1011 includes connector 202 with approximately 38 pins and NVM chip 1020. NVM chip 1020, in one aspect, includes multiple 9×4 mm NVM dies capable of storing voluminous data having a range from 128 GB to 64 TB. Diagram 1008, which is similar to diagram 1006 except that housing 1013 has been removed, illustrates PCB 1011 with dimensions.

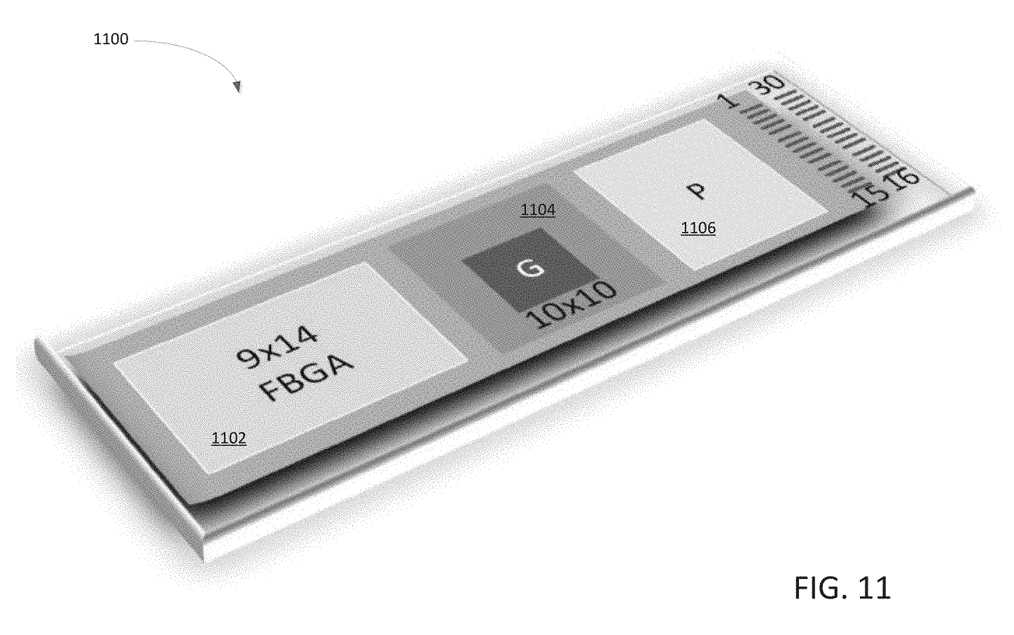

FIG. 11 is a structural diagram 1100 illustrates an alternative configuration of SNS plug using NVM packaged in Fine Pitch Ball Grid Array (“FPBA”) in accordance with one embodiment of the present invention. Diagram 1100 illustrates a cutaway view of PCB mounted to a structural housing wherein PCB includes connector 202 with approximately 30 pins, controller 1104, and NVM chip 1102. NVM chip 1102, in one aspect, is a 9×14 mm FBGA package capable of storing a large amount of data with a range from 128 GB to 64 TB. While the area of SNS plug is limited for housing NAND devices or dies, stacking SSD controller on top of NAND die(s) can be implemented to reduce power consumption while achieving high storage density. For example, NAND dies which are stacked one on top of another with 3D structure, achieve at least 500 GB or more capacities. In an alternative embodiment, the entire PCB can be configured or fabricated as a substrate package with combinations of FC (flip chip), COB (chip on board) and FOWLP (fan-out wafer level packaging platform) assembly to increase storage capacity.

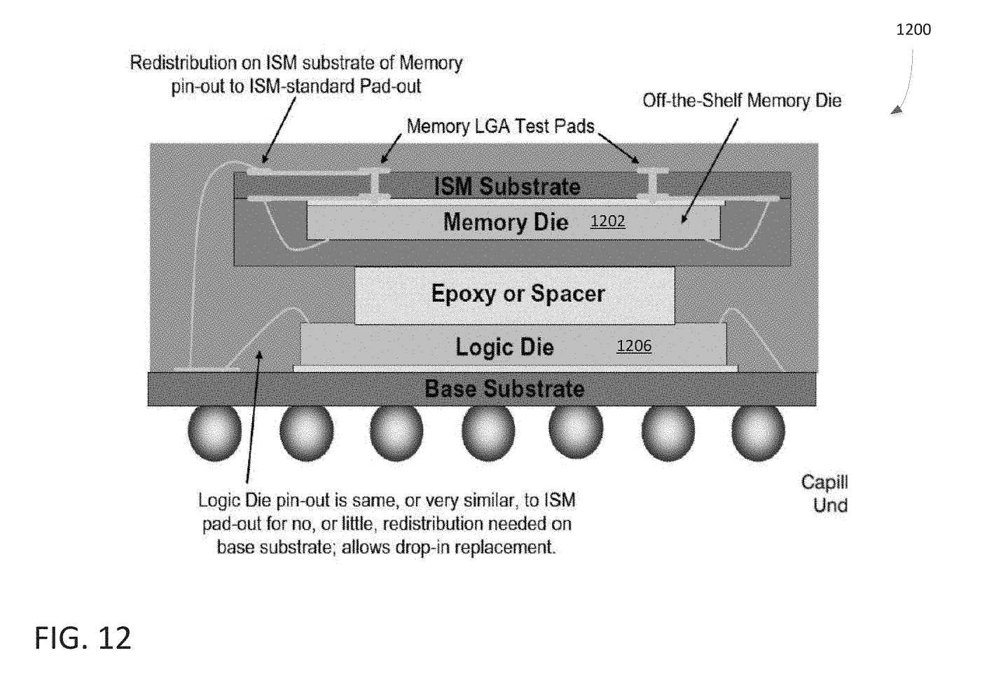

FIG. 12 is a block diagram 1200 illustrating an integrated circuit (“IC”) structure organized in 3D stacking configuration used in an SNS plug in accordance with one embodiment of the present invention. Diagram 1200 includes internal stacking module (“ISM”) substrate 1212, memory die(s) 1202, spacer 1210, logic die 1206, substrate 1214, and contacts 1216. ISM substrate 1212, in one example, includes memory land grid array (“LGA”) test pads 1204 used for device diagnosis. ISM substrate 1212 further includes pin-outs 1202 with wire bonding for signal redistribution to ISM standard pad-out. Memory die 1202, in one example, can be special NVM die(s) or off-the-shelf memory die(s) that are used for stacking on top of base substrate 1214. Between spacer 1210 which can be epoxy, logic die 1206 is placed over base substrate 1214 while memory die is placed with ISM substrate 1212. Logic die pin-outs such as pin-out 1208 are configured to reach ISM pad-out for redistribution to substrate 1214. Note that pin-out(s) can be reworked or replaced. It should be noted that the underlying concept of the exemplary embodiment(s) of the present invention would not change if one or more blocks (or devices) were added to or removed from diagram 1200.

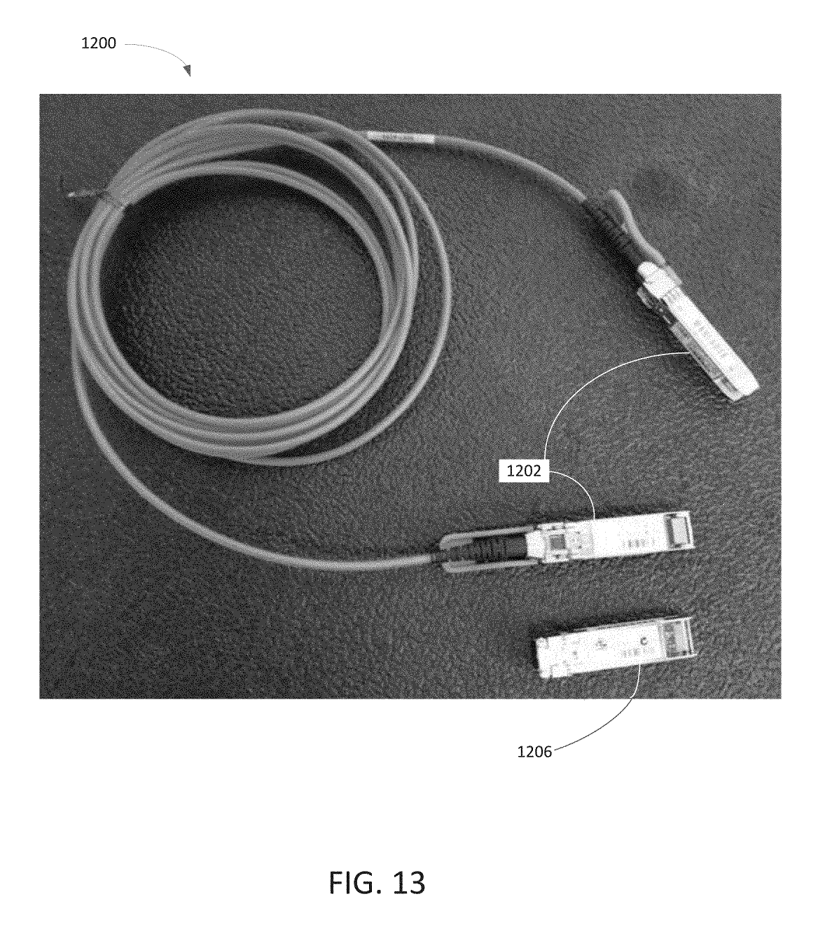

FIG. 13 illustrates exemplary QSFP and SFP MSA components including cable(s) that can be used for SNS plug or network communication in accordance with one embodiment of the present invention. Diagram 1300 illustrates optical connector 1302 with cable and SNS plug 1306. In one aspect, a digital processing system such as router is able to communicate with both optical connector 1302 for optical communication and SNS plug 1306 for external memory access.

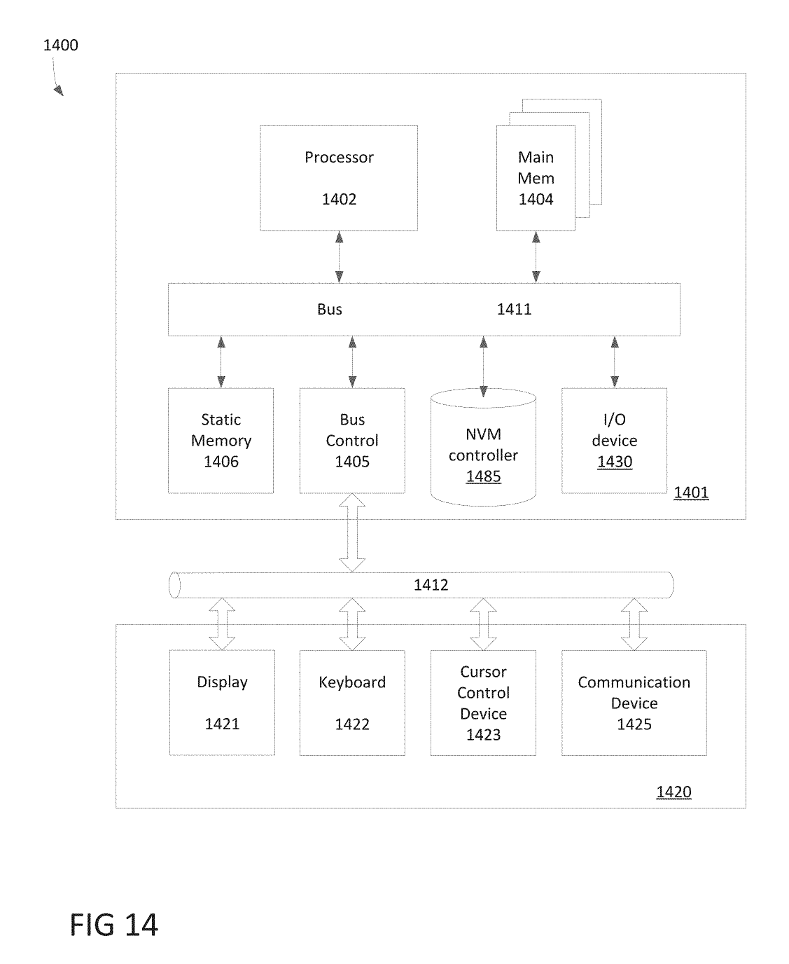

FIG. 14 is a block diagram illustrating a processing device or computer system 1400 which can be used as controller in an SNS plug or a host in accordance with one embodiment of the present invention. Computer system 1400 includes a processing unit 1401, an interface bus 1412, and an input/output (“IO”) unit 1420. Processing unit 1401 includes a processor 1402, main memory 1404, system bus 1411, static memory device 1406, bus control unit 1405, I/O element 1430, and NVM controller 1485. It should be noted that the underlying concept of the exemplary embodiment(s) of the present invention would not change if one or more blocks (circuit or elements) were added to or removed from FIG. 14.

Bus 1411 is used to transmit information between various components and processor 1402 for data processing. Processor 1402 may be any of a wide variety of general-purpose processors, embedded processors, or microprocessors such as ARM® embedded processors, Intel® Core™ Duo, Core™ Quad, Xeon®, Pentium™ microprocessor, Motorola™ 68040, AMD® family processors, or Power PC™ microprocessor.

Main memory 1404, which may include multiple levels of cache memories, stores frequently used data and instructions. Main memory 1404 may be RAM (random access memory), MRAM (magnetic RAM), or flash memory. Static memory 1406 may be a ROM (read-only memory), which is coupled to bus 1411, for storing static information and/or instructions. Bus control unit 1405 is coupled to buses 1411-1412 and controls which component, such as main memory 1404 or processor 1402, can use the bus. Bus control unit 1405 manages the communications between bus 1411 and bus 1412. Mass storage memory or SSD, which may be a magnetic disk, an optical disk, hard disk drive, floppy disk, CD-ROM, and/or flash memories may be used for storing large amount of data via I/O devices 1430.

I/O unit 1420, in one embodiment, includes a display 1421, keyboard 1422, cursor control device 1423, and communication device 1425. Display device 1421 may be a liquid crystal device, cathode ray tube (“CRT”), touch-screen display, or other suitable display device. Display 1421 projects or displays images of a graphical planning board. Keyboard 1422 may be a conventional alphanumeric input device for communicating information between computer system 1400 and computer operator(s). Another type of user input device is cursor control device 1423, such as a conventional mouse, touch mouse, trackball, or other type of cursor for communicating information between system 1400 and user(s).

Communication device 1425 is coupled to bus 1412 for accessing information from remote computers or servers, such as other server and/or computers, through wide-area network. Communication device 1425 may include a modem or a network interface device, or other similar devices that facilitate communication between computer 1400 and the network.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

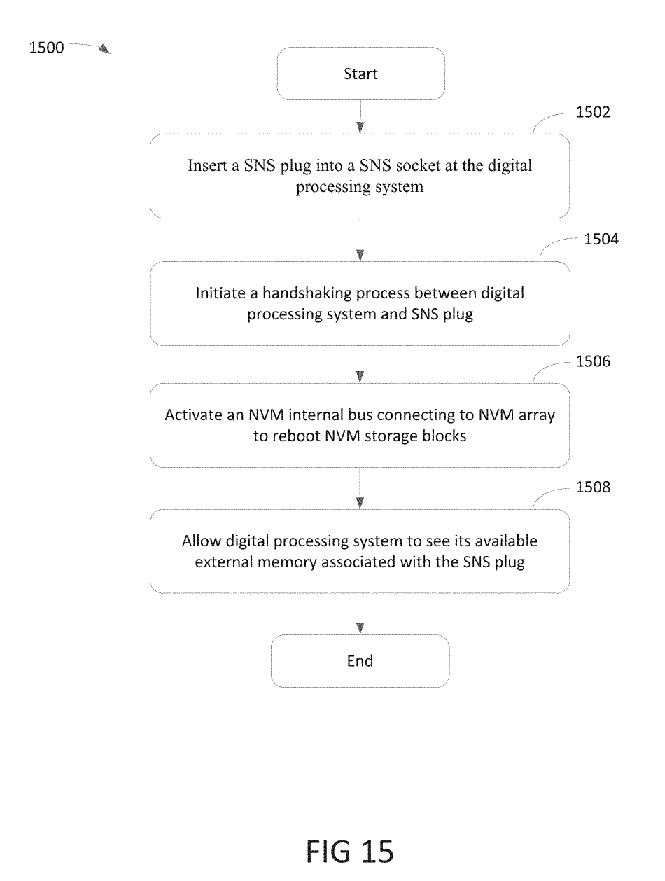

FIG. 15 is a flowchart 1500 illustrating a process of memory access to an SNS plug in accordance with one embodiment of the present invention. At block 1502, a process of providing external storage capacity to a digital processing system is capable of allowing an SNS plug to be plugged into an SFP socket of a host wherein the host is capable of using SFP socket to handle optical communication and to access external storage. In one example, before inserting the SNS plug, a coupled SFP optical transceiver which is coupled to an optical fiber is pulled or removed from the SFP socket.

At block 1504, upon insertion of an SNS plug, a handshaking process between the digital processing system and the SNS plug is initiated using an Ethernet based protocol.

At block 1506, an NVM internal bus connecting to NVM array is activated to reboot NVM storage blocks.

At block 1508, the process is capable of allowing the digital processing system or host to see its available external memory provided by the plugged SNS plug. In one aspect, upon drawing power from a power supply pin at the SFP socket for power redistribution to the SNS plug, an LED module is activated to selectively active LED lights to indicate SNS plug status.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A digital processing system capable of storing data comprising:
a host having a plurality of small form-factor pluggable (“SFP”) sockets and configured to process and store data; and
an SFP non-volatile memory (“NVM”) solid state drive (“SSD”) plug coupled to the host and configured to have a connector, interface module, memory controller, buffer, and NVM chip, wherein the host is able to perform storage access to the NVM chip of the SFP NVM SSD (“SNS”) plug via the memory controller.

2. The system of claim 1, wherein the SNS plug further includes an input output (“IO”) module coupled to the memory controller and configured to facilitate data transmission between the host and the NVM chip.

3. The system of claim 1, wherein the SNS plug further includes a plug initiator coupled to the memory controller and configured to facilitate system reboot function via boot bios.

4. The system of claim 3, wherein the plug initiator is configured to facilitate a function of hot plugging.

5. The system of claim 3, wherein the plug initiator is configured to facilitate a function of hot unplugging.

6. The system of claim 1, wherein the SNS plug further includes a thermally dissipatable housing configured to house the SNS plug and capable of dissipate heat generated by the SNS plug.

7. The system of claim 1, wherein the SNS plug further includes a power module is able to draw power from an SFP socket and redistributes the power to fulfill power requirements for the SNS plug.

8. The system of claim 1, wherein the host is one of a network router, network switch, networking hub, computer, server, and a cluster of routers, switches, hubs, and servers.

9. The system of claim 1, wherein the connector of the SNS plug includes a plurality of pins configured to provide electrical connection to the host when the SNS plug is inserted into an SFP socket.

10. The system of claim 1, wherein the interface module is able to facilitate high-speed data transfer between the host and the NVM chip via NVM over Ethernet (“NVMoE”) protocol.

11. The system of claim 1, wherein the memory controller manages NVM data transfer and reuse discarded data blocks via flash translation layer (“FTL”).

12. The system of claim 1, wherein the buffer of the SNS plug is volatile memory configured to buffer data during NVM memory access operation.

13. The system of claim 1, wherein the NVM chip includes multiple flash based NVM dies having a storage capacity in a range between one (1) gigabytes (“GB”) and 64 terabytes (“TB”).

14. A networking system capable of storing data comprising:
a network switch capable of routing data and configured to have a quad small form-factor pluggable (“QSFP”) socket; and
a QSFP non-volatile memory (“QN”) plug configured to be fitted into the QSFP socket for increasing external storage capacity to the network switch, wherein the QN plug includes a connector, interface module, controller, buffer, flash memory, input output (“IO”) module, thermal conductive housing, wherein the connector includes a plurality of pins configured to provide electrical connection to the network switch when the QN plug is in contact with the network switch via the SFP socket.

15. The system of claim 14, wherein the QN plug, having a range of height dimensions between 8 millimeter (“mm”) and 15 mm and a range of width dimensions between 13 mm and 20 mm, further includes a plug initiator coupled to the memory controller and configured to facilitate system reboot function via boot bios.

16. The system of claim 15, wherein the plug initiator is configured to facilitate a function of hot plugging and a function of hot unplugging.

17. The system of claim 14, wherein the controller manages data transfer and reuse discarded data blocks in the flash memory via flash translation layer (“FTL”).

18. The system of claim 14, wherein the buffer is volatile memory configure to buffer data during NVM memory access operation.

19. The system of claim 14, wherein the flash memory includes multiple flash based NVM dies having a storage capacity in a range between one (1) gigabytes (“GB”) and 64 terabytes (“TB”).

20. A method for providing external storage capacity to a digital processing system, comprising:
inserting a small form-factor pluggable (“SFP”) non-volatile memory (“NVM”) storage (“SNS”) plug into an SFP socket which is optical communication capable at the digital processing system;
initiating a handshaking process between the digital processing system and the SNS plug utilizing an Ethernet based protocol;
activating an NVM internal bus connecting to NVM array to reboot a plurality of NVM storage blocks; and
allowing the digital processing system to see its available external memory associated with the SNS plug.

21. The method of claim 20, wherein inserting the SNS plug into the SFP socket further includes pulling an SFP optical connector coupled to an optical fiber from the SFP socket.

22. The method of claim 20, further comprising drawing power from a power supply pin at the SFP socket for power redistribution to the SNS plug.

23. The method of claim 20, further comprising activating light-emitter diode (“LED”) module to selectively active LED lights to provide SNS plug status.
